(19) United States
(12) Patent Application Publication
(10) Pub. No.: US 2022/0180129 A1
(43) Pub. Date: Jun. 9, 2022

(54) FCN-BASED MULTIVARIATE TIME SERIES DATA CLASSIFICATION METHOD AND DEVICE

(71) Applicants: Shenzhen Academy of Inspection and Quarantine, Shenzhen (CN); Hefei University of Technology, Hefei (CN); Shenzhen Customs Information Center, Shenzhen (CN); Shenzhen Customs Animal and Plant Inspection and Quarantine Technology Center, Shenzhen (CN)

(72) Inventors: Xianyu Bao, Shenzhen (CN); Gongqing Wu, Shenzhen (CN); Yina Cai, Shenzhen (CN); Yina He, Shenzhen (CN); Changyang Tai, Shenzhen (CN); Zhouxi Ruan, Shenzhen (CN); Ze Yang, Shenzhen (CN); Jiazhu Xia, Shenzhen (CN)

(21) Appl. No.: 17/129,939

(22) Filed: Dec. 22, 2020

(30) Foreign Application Priority Data
Dec. 7, 2020 (CN) 202011418905.2

(51) Int. Cl. G06K 9/62; G06N 3/08; G06N 3/04

(52) U.S. Cl. CPC G06K 9/6267; G06N 3/0454; G06N 3/08; G06K 9/6256

(57) ABSTRACT

A FCN-based MTS data classification method is disclosed, comprising: generating input conditions according to a parameter of a multivariate Gaussian model and the MTS data; establishing correspondence between the input conditions and data categories of the MTS data via learning ability of an artificial intelligence model; determining at least one corresponding current input conditions according to current MTS of a target object; and determining current data categories corresponding to the current input conditions through the correspondence, and determining data categories corresponding to the input conditions identical to the current input conditions in the correspondence as the current data categories. The parameters of the multivariate Gaussian model corresponding to the MTS data are served as the input conditions, so that the accuracy is guaranteed, while a training speed of an artificial intelligence model is greatly improved, and the higher the data set dimension, the more significant the improvement.

### CROSS REFERENCE TO RELATED APPLICATIONS

This application claims priority to Chinese Patent Application No. 202011418905.2, filed Dec. 7, 2020, which is hereby incorporated by reference herein in its entirety.

### BACKGROUND

### 1. Technical Field

The present disclosure relates to a data processing field, and more particularly to a fully convolutional networks (FCN)-based multivariate time series (MTS) data classification method.

### 2. Description of Related Art

Time series data is widely applied in our lives. A large amount of time series data is generated for weather forecasting, stock markets, medical care, human activity recognitions and other fields every day. The main feature of the time series data is to index a series of data points in a chronological order. Any data with a time series attribute can be served as time series data. With the improvement of data acquisition and storage capabilities, in practical applications, the demand for analysis to the time series data is increasing. How to perform accurate time series classification is one of the most challenging problem in data mining. In cardiology, electrocardiography (ECG) signals are classified to distinguish heart patients from healthy people. In anomaly detection, any types of abnormal behaviors are detected by monitoring user system access activities on Unix systems. Regarding human activity recognition, human activity judgement detected based on data collected by sensors is also a typical time series classification problem.

The time series data can be divided into the univariate time series (UTS) and the multivariate time series (MTS). Since the UTS can only describe the property of a certain aspect of things and cannot satisfy most application fields. Nowadays, researchers focus on MTS classification. The research in this article is also aimed at multivariate time series classifications. The MTS can be regarded as a collection of multiple UTS, and, however, interactions between variables may be still detected. Therefore, the MTS should be treated in its entirety. In the face of high-dimensional MTS, how to mine the relationship between variables has become a huge challenge in the field of the MTS classification.

In recent years, the introduction of deep learning methods has brought gratifying results for the MTS classification. Compared with traditional methods of extracting features by manually constructing rules to and design models, deep learning algorithms can learn features automatically. These features can extract rich information contained in data and achieve better classification results. However, the training of various parameters in a neural network is a huge overhead. Even with the rapid development of computer hardware and the significant increase in computing power, the training speed of a model is still relatively slow.

### BRIEF DESCRIPTION OF DRAWINGS

FIG. 1 is a flowchart of a fully convolutional networks (FCN)-based multivariate time series (MTS) data classification method in accordance with an embodiment of the present disclosure;

FIG. 2 is a block diagram of the hardware architecture of a GM-FCN model in accordance with an embodiment of the present disclosure; and

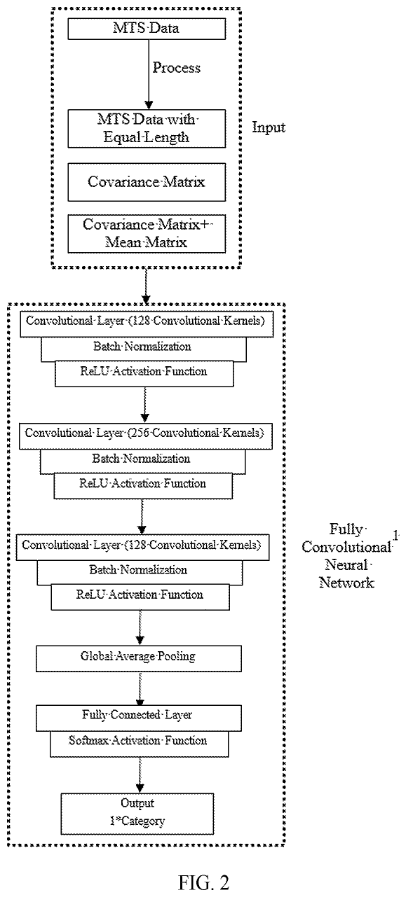

FIG. 3 is a block diagram of functional blocks of an FCN-based MTS data classification device in accordance with an embodiment of the present disclosure.

### DETAILED DESCRIPTION

To clarify the purpose, technical solutions, and the advantages of the disclosure, embodiments of the invention will now be described more fully hereinafter with reference to the accompanying drawings, in which embodiments of the invention are shown.

As used herein, the term “main control process” refers to a computer-implemented process/method for a physical component. The main control process may be a sub-process, in one example.

It should be noted that, regarding different deep learning methods, the present invention applies FCN (Fully Convolutional Networks) capable of excellent performance to MTS classification. In view of the fact that parameters of a multivariable Gaussian model can be used to not only automatically recognize and capture correlation between different variables, but also perform dimensionality reduction to a high-dimensional MTS. The present invention integrates a multivariate Gaussian model and considers converting original MTS data into parameters of the multivariable Gaussian model to be an input of a neural network, and proposes an FCN-based multivariate time series (MTS) data classification method. Specifically, the present invention designs three different input forms, explores experimental effects of the three input methods, and discovers that, regarding high-dimensional data, the parameters of the multivariate Gaussian model are used as input to achieve good performance, so that the training of the neural network is greatly speeded up without loss of accuracy.

It should be noted that time series data is a series of observation values indexed by timestamps over a period of time, which can be written as:

X={x₁,x₂, . . . ,xₘ},

where xᵢ={xᵢ(1), xᵢ(2), . . . xᵢ(n)}, m is the number of variables, n is the number of the observation values. When m=1, xᵢ indicates the univariate time series (UTS), and, when m≥2, X indicates the MTS. The MTS can be regarded as a set of multiple UTSs.

A data set D={(X₁,Y₁), (X₂,Y₂), . . . (X_{N},Y_{N})} which is a set of (Xᵢ, Yᵢ), where Xᵢ indicates the UTS or the MTS and Yᵢ indicates a corresponding one-hot label vector. Regarding a data set including K categories, the one-hot label vector Yᵢ is a vector with a length K. if the category of Xᵢ is j, each element of j∈[1,K] is set to 1 and, otherwise, is set to 0.

The task of time series classification is to train classification models using the training data, and then generate a mapping relationship between the time series and correct labels of the time series through classification performance of a test model of a test data set.

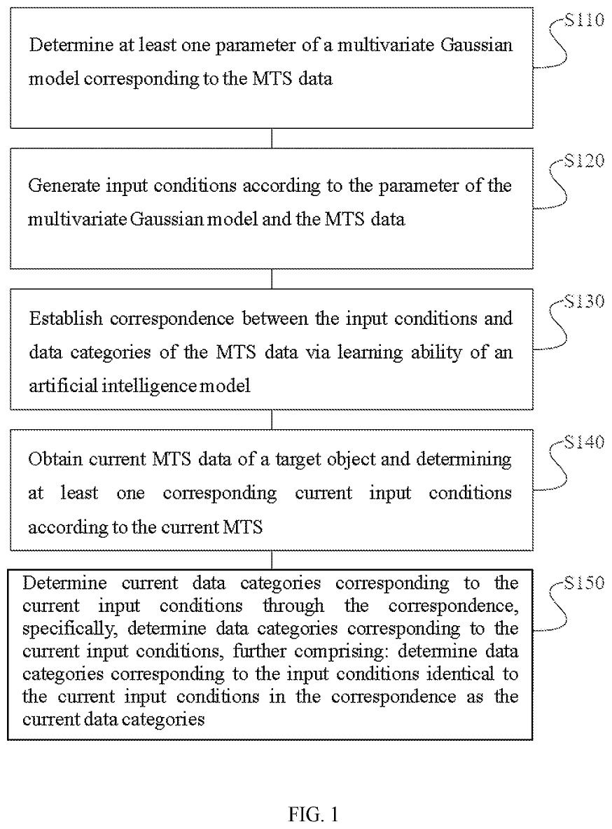

Referring to FIG. 1, which is a flowchart of an FCN-based MTS data classification method in accordance with an embodiment of the present disclosure, comprising:

In step S110, at least one parameter of a multivariate Gaussian model corresponding to the MTS data is determined.

In step S120, input conditions are generated according to the parameter of the multivariate Gaussian model and the MTS data.

In step S130, correspondence between the input conditions and data categories of the MTS data is established via learning ability of an artificial intelligence model.

In step S140, current MTS data of a target object is obtained and at least one corresponding current input conditions is determined according to the current MTS.

In step S150, current data categories corresponding to the current input conditions are determined through the correspondence. Specifically, data categories corresponding to the current input conditions are determined, further comprising that data categories corresponding to the input conditions identical to the current input conditions in the correspondence are determined as the current data categories.

In the embodiment of the present application, steps S110-S150 are passed. The parameters of the multivariate Gaussian model corresponding to the MTS data are served as the input conditions, so that the accuracy is guaranteed, while a training speed of an artificial intelligence model is greatly improved, and the higher the data set dimension, the more significant the improvement.

Hereinafter, the FCN-based MTS data classification method in this exemplary embodiment will be further explained.

As described in step S110, the parameter of the multivariate Gaussian model corresponding to the MTS data is determined.

It should be noted that the multivariate Gaussian distribution is a high-dimensional generalization of a unary normal distribution. Different from a traditional Gaussian model, the multivariate Gaussian model is capable of automatically recognizing and capturing the correlation between feature variables, so the multivariate Gaussian model is very suitable for processing multivariate data.

Specifically, models established by a univariate Gaussian distribution assume that there is no correlation between different feature variables, only individual changes of each of the feature variables are considered for probability density thereof, and cannot recognize correlation information between the features variables, so that requirements of the MTS data cannot be satisfied. The multivariate Gaussian model can automatically recognize and capture direct correlation of different variables without the need to establish new features. A multivariate Gaussian model can be directly constructed for processing multivariate ordered data sets (different variables are not independent of each other)

In an embodiment, the specific process of “determining the parameter of the multivariate Gaussian model corresponding to the MTS data” in step S110 may be further described in conjunction with the following description.

As described in the following step, a mean matrix of a feature included in the MTS data is determined according to multivariate Gaussian distribution.

As described in the following step, a covariance matrix corresponding to a relevant quantization result of the feature of the MTS data is generated according to the mean matrix.

As an example, m-dimensional data is given as {x₁, x₂, . . . , xₘ}, where xᵢ={xᵢ(1), xᵢ(2), . . . xᵢ(n)}, n is the number of the observation values of the variables. The mean matrix of all features can be calculated from the multivariate Gaussian distribution as μ, as shown in the following formula:

$$μ = \frac{1}{m} {\sum }_{j = 1}^{m} {x}_{i} .$$

The formula for the covariance matrix Σ of all features is represented as:

$$Σ = \frac{1}{m} {\sum }_{i = 1}^{m} ( {x}_{i} - μ ) {( {x}_{i} - μ )}^{T} .$$

Converting the MTS data with variable lengths into the parameters of the multivariate Gaussian model has two advantages. First, it is possible to map the MTS data with different lengths to the same size of a space, that is, related to the size of the dimensions of the variables. Second, the multivariate Gaussian model can quantify interactions between different features via use the covariance matrix and automatically recognize and capture the correlation between the multivariate features.

As described in step S120, the input conditions are generated according to the parameter of the multivariate Gaussian model and the MTS data.

It should be noted that since an input requirement of the FCN must be the MTS data with an equal length, the FCN cannot directly process the MTS data. With variable lengths. Referring to practical problems, the length of each piece of the MTS data is usually inconsistent. For example, a JapaneseVowels (Japanese vowels) data set provided by a University of California Irvine (UCI) machine learning library collected nine male speakers that they speak two consecutive Japanese vowels /ae/, one utterance for each speaker forms a time series whose length is in the range of 7-29. Therefore, the pieces of original MTS data with different lengths should be pre-processed to be mapped to the same length.

In an embodiment, the specific process of “generating the input conditions according to the parameter of the multivariate Gaussian model and the MTS data” in step S120 may be further described in conjunction with the following description.

As described in the following step, the MTS data is filled using cubic spline interpolation to generate multiple pieces of MTS data with an equal length.

It should be noted that the MTS with a short length are interpolated and filled by interpolation. The interpolation is an important method for discrete function approximation. An approximate value of the function at other points can be estimated through values at a finite number of points calculated using a specific function. The spline interpolation is an interpolation method commonly used in industrial design to obtain smooth curves, in which the cubic spline is usually used. The interpolation method applied in this embodiment is the cubic spline interpolation method, which can smoothly fill the original MTS data with a shorter length to become the MTS data with the longest length in the current data set. The specific calculation process is shown in the following Algorithm 1:

Algorithm 1 Obtaining Time Series Datasets with Equal Length.

Input: The train datasets Train_X and the test datasets Test_X.

Output: The equal-length train datasets Train_X′ and the equal-length test datasets Test_X′.

1. Lₜᵣₐᵢₙ←max length(Train_X);

2. Lₜₑₛₜ←max length(Test_X);

3. Lₘₐₓ←max(Lₜᵣₐᵢₙ, Lₜₑₛₜ);

4. Train_X′←Cubic Spline Interpolation(Train_X, Lₘₐₓ); and

5. Test_X′←Cubic Spline Interpolation(Test_X, Lₘₐₓ).

where Lₜᵣₐᵢₙ represents the length of the longest sample in the training set, Lₜₑₛₜ represents the length of the longest sample in the testing set, and Lₘₐₓ represents the length of the longest sample in the training set and the testing set.

As described in the following step, a mean matrix of the multivariate Gaussian model corresponding to the MTS data is generated.

As described in the following step, the mean matrix and the covariance matrix are spliced to generate a target matrix.

It should be noted that in this embodiment, the parameters of the multivariate Gaussian model are served as the input of the FCN. The specific calculation process is shown in the following Algorithm 2. In this way, in contrast to the length of the high-dimensional MTS data, the dimension size of the high-dimensional MTS data is exceedingly small. However, when the model training is performed, if the original MTS data is replaced by the parameters of the multivariable Gaussian model and the parameters are served as the input of the FCN, a lot of calculation amount can be reduced to achieve the purpose of improving the speed of the model training.

Algorithm 2 Obtaining Mean and Covariance Matrix.

Input: The multivariate time series sample X.

Output: The mean μ, the covariance matrix Σ and the matrix C concatenated by the mean and covariance matrix.

1. μ←mean(X);

2. Σ←covariance(X); and

3. C←concatenation(Σ, μ).

As described in the following step, the input conditions are generated according to the pieces of the MTS data with the equal length, the covariance matrix and the target matrix.

In summary, the input served as the artificial intelligence model in this embodiment includes three forms of time series data generated through the above steps:

1. the MTS with an equal length obtained by the cubic spline interpolation;

2. the covariance matrix of the multivariate Gaussian model; and

3. a new matrix obtained by splicing the covariance matrix and the mean matrix of the multivariate Gaussian model.

As described in step S130, correspondence between the input conditions and data categories of the MTS data is established via learning ability of an artificial intelligence model.

It should be noted that the FCN of this embodiment is composed of three convolutional layers, and each convolutional layer contains three operations: convolution, batch normalization, and the result is fed to a ReLU activation function. The global average pooling layer calculates average values of each of the feature matrixes of the result of the third convolutional layer, and the average values are inputted in a fully connected layer classifier activated by a Softmax function, in which the number of neurons is equal to the number of categories in the data set.

As an example, the convolutional layer of the artificial intelligence model:

The convolutional layer in the FCN is served as a feature extractor, which can be expressed as:

y=W⊗x+b

s=BN(y).

h=ReLU(s)

The final network is constructed by stacking the three convolutional layers, where ⊗ is a convolution operator, BN( ) represents the batch normalization and ReLU( ) represents the activation function.

Convolutional

The convolution kernel can convert a child node matrix on the current layer of the neural network into a unit node matrix on the next layer of the neural network. The unit node matrix refers to a node matrix with both the length and width equal to 1 and the depth equal to the number of convolution kernels. To extract more features, the three convolutional layers in the FCN contain 128, 256 and 128 convolution kernels. The sizes of the convolution kernels are 8*8, 5*5 and 3*3. Parameters of the convolution kernels used in a convolution layer are the same. To keep the size of the forward propagation result matrix of the convolutional layer to be consistent with the size of the matrix of the current layer, the zero-padding is used at the matrix boundary of the current layer.

Assuming that α is the input matrix, w_{x,y,z}ⁱ represents a weight of an input node (x, y, z) of the convolution kernel for the i-th node in outputted unit node matrix and bⁱ represents an offset item parameter corresponding to the i-th output node. The value g(i) of the i-th node in the unit matrix is represented as:

$$g ( i ) = f ( {\sum }_{x = 1}^{m} {\sum }_{y = 1}^{n} {\sum }_{z = 1}^{c} {a}_{x , y , z} * {w}_{x , y , z}^{i} + {b}^{i} ) , \qquad ( i )$$

where f( ) is a currently used activation function.

Batch Normalization

During the training process, input distributions of each layer changes with the changes of parameters of the previous layer, which makes the training of the deep neural networks more complicated. Weights of each layer in the network must be readjusted according to the different distributions of the inputs of each training batch, thereby slowing down the training speed of the model.

If the distributions of the inputs in each layer can be more similar, the network can focus on learning the differences between categories. Google proposed a technique for training the deep neural network: Batch Normalization (BN). The batch normalization performs normalize to a certain training batch of data during the training process. The batch normalization first calculates the mean and variance of data of a training batch and performs the normalization to the data of the training batch according to the mean and variance to obtain a normal distribution \hat{x}ᵢ with the mean equal to zero and the variance equal to one, \hat{x}ᵢ is represented as:

$${\hat{x}}_{i} = \frac{{x}_{i} - {μ}_{x}}{\sqrt{{σ}_{x}^{2} + ɛ}} ,$$

where μₓ is the mean of the current training batch; σₓ² is the variance of the current training batch, and ε is used to prevent the denominator from being zero.

Since the normalized data is basically restricted to a normal distribution, the expressive ability of the network is reduced. Accordingly, two new parameters γ and β are introduced in the batch normalization to transform and offset the data distribution. This process is the key to the batch normalization that γ and β are obtained via the automated learning of the neural network during the training process:

yᵢ=γ\hat{x}ᵢ+β.

ReLU Activation Function

The non-saturated and nonlinear ReLU function is selected as the activation function in the convolution block. The ReLU function cuts off the part of x<0 on the basis of x=0, only the positive input part is reserved, the formula thereof is: y=max{0,x}. The ReLU function has good sparsity and excellent nonlinear characteristics, and the calculation thereof is more efficient.

Global Average Pooling

The traditional CNN connects several fully connected layers after feature extraction is performed to the original data by the convolutional layer, maps the feature map generated by the convolutional layer into a fixed-length feature vector, and performs classification through the activation function. However, the fully connected layer has a disadvantage that the parameter amount is excessively large, especially for the fully connected layer connected to the last convolutional layer. Thus, a global average pooling layer (GAP) is added to the FCN after the last convolution layer. ResNet also uses this strategy to convert each feature map of the last convolution layer into a feature value. Accordingly, the number of parameters is reduced and the calculation amount of the training model is also reduced, while the possibility of overfitting caused by too many parameters is reduced.

Fully Connected Layer

Each node of the fully connected layer is connected to all the nodes of the previous layer, which integrates the features previously extracted from the convolutional layer and the global average pooling layer. The fully connected layer is served as a classifier in the FCN, which performs basic calculations using the following formula.

h=X@W+b,

where h represents an output child node of the fully connected layer, X represents an input matrix, W represents a weight matrix; @ represents a dot product operator; and b represents a bias term which is a scalar.

As the output of the fully connected layer is obtained, the final classification result is obtained through the activation function. The Softmax activation function is used at the end of the network. The Softmax function can map outputs of multiple neurons to the (0,1) interval and further satisfy the characteristic that the sum of all output values is 1. The result of the output layer which is activated by the Softmax function can be regarded as probabilities belonging to each of the categories, so as to perform multiple categories. The Softmax function is defined as:

$$σ ( {x}_{i} ) = \frac{{e}^{{x}_{i}}}{{\sum }_{j = 1}^{n} {e}^{{x}_{j}}} . \qquad ( xi )$$

In an embodiment, the specific process of “establishing the correspondence between the input conditions and the data categories of the MTS data via the learning ability of the artificial intelligence model” in step S130 may be further described in conjunction with the following description.

Sample data used to establish the correspondence between the input conditions and the data categories is obtained.

Characteristics and rules of the input conditions are analyzed and a network structure and network parameters of an artificial neural network are determined according to the characteristics and the rules.

The network structure and the network parameters are trained and tested using the sample data and determining the correspondence between the input conditions and the data categories.

In an embodiment, the step of obtaining sample data used to establish the correspondence between the input conditions and the data categories further comprises:

collecting the input conditions and the data categories of different data sources;

analyzing the input conditions and integrating pre-stored expert experience information to select data related to the data categories as the input conditions; and

regarding data pairs constituted by the data categories and the selected input conditions as the sample data.

In an embodiment, the network structure and the network parameters are trained, further comprising:

selecting a portion of the sample data as a training sample, inputting the input conditions in the training sample in the network structure, and performing the training by activating a loss function of the network structure and the network parameters to obtain an actual training result;

determining whether an actual training error between the actual training result and corresponding data categories in the training sample corresponds to a preset training error;

when the actual training error corresponds to the preset training error, determining that the training of the network structure and the network parameters is completed;

and/or,

testing the network structure and the network parameters, further comprising:

selecting another portion of the sample data as a test sample, inputting the input conditions in the test sample in the network structure which has been trained, and performing the training via activating the loss function and the network parameters which have been trained to obtain an actual testing result;

determining whether an actual testing error between the actual testing result and corresponding data categories in the testing sample corresponds to a preset testing error; and

when the actual testing error corresponds to the preset testing error, determining that the testing of the network structure and the network parameters is completed.

In an embodiment, the network structure and the network parameters are trained, further comprising:

when the actual training error does not correspond to the preset training error, updating the network parameters through an error loss function of the network structure;

re-performing the training by activating the loss function and the updated network parameters until the re-trained actual training error corresponds to the preset training error;

and/or,

testing the network structure and the network parameters, further comprising:

when the actual testing error does not correspond to the preset testing error, re-testing the network structure and the network parameters until the re-trained actual testing error corresponds to the preset testing error.

As described in step S140, current MTS data of a target object is obtained and at least one corresponding current input conditions is determined according to the current MTS.

As described in step S150, current data categories corresponding to the current input conditions are determined through the correspondence. Specifically, data categories corresponding to the current input conditions are determined, further comprising that data categories corresponding to the input conditions identical to the current input conditions in the correspondence are determined as the current data categories.

In a specific implementation, the MTS classification method (KLD-GMC) based on the Kullback-Leibler divergence and the Gaussian model is used as the baseline. Four real high-dimensional data sets are selected from the UCI machine learning library and the Graphics Lab Motion Capture Database of the Carnegie Mellon University (CMU) to evaluate classification performances generated by inputting data from different pre-processed operations in the FCN network.

Specifically, the UCI machine learning library provides a data set, the JapaneseVowels data set. The JapaneseVowels data set collects voices with two Japanese vowels /ae/ spoke by nine male. A 12-degree linear predictive analysis process is applied to each speech sample to form 640 discrete time series containing 12 LPC cepstral coefficients (i.e. MTS samples with 12 variables), and the length of each MTS sample is located between 7 and 29. The total number of the samples in the data set is 640, in which 270 are used as the training set and 370 are used as the testing set. The classification goal is to distinguish nine male speakers by the pronunciation of the two Japanese vowels /ae/.

The CMU established a Graphics Lab Motion Capture Database, from which the WalkvsRun data set, the KickvsPunch data set and the CMUsubject16 data set are selected for verification of this specific implementation. Table 1 shows relevant information of all data sets.

TABLE 1

| | | | | ins- | training | test |
|---|---|---|---|---|---|---|
| Name | attributes | classes | Length | tances | set | set |
| JapaneseVowels | 12 | 9 | 7~29 | 640 | 270 | 370 |
| CMUsubject16 | 62 | 2 | 127~580 | 58 | 29 | 29 |
| KickvsPunch | 62 | 2 | 274~841 | 26 | 16 | 10 |
| WalkvsRun | 62 | 2 | 128~1918 | 44 | 28 | 16 |

According to the requirements of the method in the present application, the four data sets are preprocessed to obtain the data with the equal length obtained by the interpolation and the covariance matrix and the mean matrix calculated. The sizes of the three types of input data obtained are shown in Table 2:

TABLE 2

| Name | original | cov | cov_mean |
|---|---|---|---|
| JapaneseVowels | 29*12 | 12*12 | 13*12 |
| CMUsubject16 | 580*62 | 62*62 | 63*62 |
| KickvsPunch | 841*62 | 62*62 | 63*62 |
| WalkvsRun | 1918*62 | 62*62 | 63*62 |

In Table 2, referring to the JapaneseVowels data with the equal-length MTS (original), 29 is the length of the longest sample in the data set, and 12 is the dimension of the data set. The size of the obtained covariance matrix is 12*12, while the size of the mean matrix is 1*12. Accordingly, the input size of the covariance matrix (cov) is 12*12, while the size of the new matrix (cov_mean) obtained by splicing the covariance matrix and the mean matrix is 13*12.

This specific implementation is verified through the following three sets of comparative experiments, respectively including:

1. The FCN model obtained by training the MTS data with the equal length is compared with the KLD-GMC to verify whether the FCN is suitable for the classification of the MTS data.

2. Identical FCN models are used, the MTS data with the equal length and the parameters of the multivariate Gaussian model are respectively inputted to train the FCN. The model classification results are compared to verify whether the process of training the models using the parameters of the multivariate Gaussian model provides a good classification effect.

3. Comparison and analysis are performed through the time consumption caused by training of a sample using the FCN network, which verifies whether the process of converting the MTS into the parameters of the multivariate Gaussian model to be used as the training data can improve the training speed of the models.

Evaluation Criteria: The performance of the method proposed in this application is measured by the accuracy. In addition, the time consumption of the process of training model is also considered that, compared with different forms of data input, the length of time required for FCN to train a sample is presented.

The classification results of the comparative experiments are shown in Table 3, while the time consumption results of a sample of the comparative training are shown in Table 4.

TABLE 3

| Name | KLD-GMC | FCN_mts | FCN_cov | FCN_cov_mean |
|---|---|---|---|---|
| JapaneseVowels | 0.981 | 0.992 | 0.843 | 0.989 |
| CMUsubject16 | 1.000 | 1.000 | 1.000 | 0.966 |
| KickvsPunch | 0.700 | 0.900 | 1.000 | 1.000 |
| WalkvsRun | 1.000 | 1.000 | 1.000 | 1.000 |
| AVG_Acc | 0.920 | 0.973 | 0.961 | 0.989 |

The results of the first set of experiments are observed. According to the results in the second column of Table 3, it can be seen that the FCN classification model directly trained and obtained via the MTS training can achieve good results. On the basis of the KLD-GMC, the accuracy has been further improved, which proves that the FCN is indeed suitable for classification of the MTS data, automatically extracts effective features, and trains an excellent time series classification model.

Followed by the second set of comparative experiments, the last three columns of Table 3 are observed, the same FCN model is used, and the results of the model training by inputting the MTS with the equal length and the parameters of the multivariate Gaussian model are compared. Based on the experimental results on the multiple data sets, the highest average accuracy rate is the FCN model obtained by training via the parameters of the multivariable Gaussian model, which shows that the model parameters contain enough information to train a high-quality MTS classification model. However, regarding some data sets, the performance of the model trained by the model parameters is slightly lower than that of the model trained by the original MTS data. It is believed that the reason for this result is that when MTS is converted to the parameters of the multivariate Gaussian model, although the covariance can recognize and capture the correlation information between variables, it may ignore the characteristics of variable values changing with time and lose part of the time series information. However, it can also be seen from the classification results that the performance is still very superior, which shows that it makes sense to use the model parameters as the input data to train the neural network model. The model parameters do extract important information from the original MTS data. The neural network model can learn features determining the classification of the MTS data based on this information.

The results in the last two columns of Table 3 are compared to observe the classification results using the covariance matrix and the splicing matrix training model. In most data sets, splicing matrixes provides better effect, indicating that the mean is also an important attribute of the MTS data. It is believed that the mean reflects the characteristics of the MTS to a certain extent on the overall level. Splicing the mean matrix to the covariance matrix can increase the information amount input in the model, provides more information to the neural network for training, and gets a better classification model. There is also a problem. Although it is considered that the covariance matrix and the mean matrix are spliced together to increase the input information, the splicing of the two model parameters is simple and not reasonable enough. When the convolution kernel moves to the last line, the convolution kernel performs convolution operations to the parameters of the mean and a portion of parameters of the covariance, the neural network may be confused in extracting features and fails to accurately recognize the features, thereby declining the classification result. In response to this problem, especially for low-dimensional data sets, a better combination method should be designed to combine these two parameters and make full use of existing information.

TABLE 4

| Name | FCN_mts | | FCN_cov | | FCN_cov_mean | |
|---|---|---|---|---|---|---|
| JapaneseVowels | 734 | us | 504 | us | 537 | us |
| CMUsubject16 | 41000 | us | 3000 | us | 4000 | us |
| KickvsPunch | 127000 | us | 4000 | us | 3000 | us |
| WalkvsRun | 184000 | us | 4000 | us | 3000 | us |

Table 4 shows the time consumption of the FCN model training one sample via different input forms. The size of the covariance matrix is close to that of the splicing matrix, while the time consumption of the FCN training model is approximately equal. Compared with the size of the data input shown in Table 2, it can be clearly seen that converting the MTS into the parameters of the multivariable Gaussian model can greatly reduce the amount of data input by the neural network and reduce the calculation amount. The results in Table 4 also show that, in view of the data set (WalkvsRun data set) with the length of the data sample is much greater than the dimension of the data sample, the training time can even be reduced by dozens of times. For many high-dimensional data sets, the dimensionality thereof is much smaller than their data length. Converting the MTS data to the parameters of the multivariate Gaussian model can greatly reduce the data dimensionality and the training time. At the same time, the multivariate Gaussian model is good at recognizing and capturing the correlation information between the variables. Therefore, the FCN-based MTS classification method combined with the parameters of the multivariate Gaussian model is very suitable for applying to a high-dimensional long-time series.

As for the device embodiment, it is basically similar to the method embodiment, the description is relatively simple, and the relevant part can refer to the part of the description of the method embodiment.

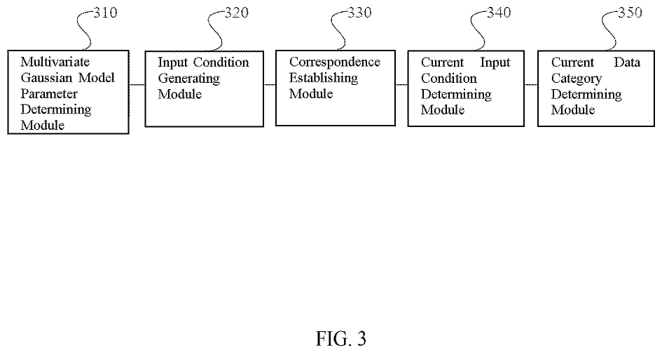

Referring to FIG. 3, which is a block diagram of functional blocks of an FCN-based MTS data classification device in accordance with an embodiment of the present disclosure, specifically comprises:

a multivariate Gaussian model parameter determining module 310, configured to determine at least one parameter of a multivariate Gaussian model corresponding to the MTS data;

an input condition generating module 320, configured to generate input conditions according to the parameter of the multivariate Gaussian model and the MTS data;

a correspondence establishing module 330, configured to establish correspondence between the input conditions and data categories of the MTS data via learning ability of an artificial intelligence model;

a current input condition determining module 340, configured to obtain current MTS data of a target object and determine at least one corresponding current input conditions according to the current MTS; and

a current data category determining module 350, configured to determine current data categories corresponding to the current input conditions through the correspondence, specifically, determine data categories corresponding to the current input conditions, further configured to: determine data categories corresponding to the input conditions identical to the current input conditions in the correspondence as the current data categories.

In an embodiment, the multivariate Gaussian model parameter determining module 310 further comprises:

a mean matrix determination submodule, configured to determine a mean matrix of a feature included in the MTS data according to multivariate Gaussian distribution; and

a covariance matrix generation sub-module, configured to generate a covariance matrix corresponding to a relevant quantization result of the feature of the MTS data according to the mean matrix.

In an embodiment, the input condition generating module 320 further comprises:

an isometric multivariate time series data generating sub-module, configured to fill the MTS data using cubic spline interpolation to generate multiple pieces of MTS data with an equal length;

a mean matrix generating submodule, configured to generate a mean matrix of the multivariate Gaussian model corresponding to the MTS data;

a target matrix generating sub-module, configured to splice the mean matrix and the covariance matrix to generate a target matrix; and

an input condition generating sub-module, configured to generate the input conditions according to the pieces of the MTS data with the equal length, the covariance matrix and the target matrix.

In an embodiment, the correspondence establishing module 330 further comprises:

an obtaining submodule, configured to obtain sample data used to establish the correspondence between the input conditions and the data categories;

an analyzing submodule, configured to analyze characteristics and rules of the input conditions and determine a network structure and network parameters of an artificial neural network according to the characteristics and the rules; and

a training submodule, configured to train and test the network structure and the network parameters using the sample data and determine the correspondence between the input conditions and the data categories.

In an embodiment, the obtaining submodule further comprises:

A collecting submodule, configured to collect the input conditions and the data categories of different data sources;

an analyzing submodule, configured to analyze the input conditions and integrate pre-stored expert experience information to select data related to the data categories as the input conditions; and

a sample data generating sub-module, regard data pairs constituted by the data categories and the selected input conditions as the sample data.

In an embodiment, the testing submodule further comprises:

a training result generating sub-module, configured to select a portion of the sample data as a training sample, input the input conditions in the training sample in the network structure, and perform the training by activating a loss function of the network structure and the network parameters to obtain an actual training result;

a training result error judging sub-module, configured to determine whether an actual training error between the actual training result and corresponding data categories in the training sample corresponds to a preset training error;

a training completion judging sub-module, configured to, when the actual training error corresponds to the preset training error, determine that the training of the network structure and the network parameters is completed;

and/or,

a testing submodule, configured to test the network structure and the network parameters, further comprising:

a testing result generating sub-module, configured to select another portion of the sample data as a test sample, input the input conditions in the test sample in the network structure which has been trained, and perform the training via activating the loss function and the network parameters which have been trained to obtain an actual testing result;

a testing result error judging sub-module, configured to determine whether an actual testing error between the actual testing result and corresponding data categories in the testing sample corresponds to a preset testing error; and

A testing completion judging sub-module, configured to, when the actual testing error corresponds to the preset testing error, determine that the testing of the network structure and the network parameters is completed.

In an embodiment, the training submodule further comprises:

a network parameter updating submodule, configured to, when the actual training error does not correspond to the preset training error, update the network parameters through an error loss function of the network structure;

a first retraining sub-module, configured to re-perform the training by activating the loss function and the updated network parameters until the re-trained actual training error corresponds to the preset training error;

and/or,

the training submodule further comprises:

A second training sub-module, configured to, when the actual testing error does not correspond to the preset testing error, re-test the network structure and the network parameters until the re-trained actual testing error corresponds to the preset testing error.

It should be understood that the size of the sequence number of each step in the foregoing embodiments does not mean the execution sequences. The execution sequence of each process should be determined by its function and internal logics, and should not constitute any limitation on the implementation process of the embodiments of the present application.

It should be noted that the information exchange and execution processes among the above-mentioned devices/units are based on the same concept as the embodiments of the method of this application. The specific functions and technical effects of the present disclosure can be found in the embodiments of the methods, which is not repeated here.

The person skilled in the art may clearly understand that for the convenience and simplicity of the description, the function units and the units described in above are merely examples. Practically, the functions may be accomplished by different function units or units. That is, the internal structure of the device may include different function units or units to accomplish the total or partial functions described in above. Each of the functional units in the various embodiments of the present invention may be integrated into one processing unit. Each of the units may be physically present, or two or more units may be integrated into one unit. The above-mentioned integrated unit can be implemented either in the form of hardware or in the form of computer programs functional units. In addition, the name of each of the function units and the units is merely for the convenience of distinguishing one and the other, and may not limit the claim scope of the present disclosure. The operational process of the units within the system may refer to the process of the embodiment of the method, and may not be described again.

In the above-mentioned embodiments, the description of each embodiment has its own focus. For parts that are not detailed or recorded in an embodiment, reference may be made to related descriptions of other embodiments.

The person skilled in the art may notice that the steps and the units described in the present disclosure may be achieved by the electronic components or the combination of the computer programs and the electronic components. The detailed specification may determine whether the functions are achieved by the electronic components or the computer programs. The person skilled in the art may adopt different ways, which does not beyond the scope of the present disclosure, to achieve each of the specific applications.

In addition, each of the functional units in the various embodiments of the present invention may be integrated into one processing unit. Each of the units may be physically present, or two or more units may be integrated into one unit. The above-mentioned integrated unit can be implemented either in the form of hardware or in the form of software functional units.

The integrated modules/units in the above-described other embodiments may be stored in a computer-readable storage medium when being implemented in the form of software functional units and are sold or used as stand-alone products. Based on this understanding, the technical solution of the present disclosure, either essentially or in part, contributes to the prior art, or all or part of the technical solution may be embodied in the form of a software product stored in a storage medium. In an example, the computer-readable storage medium includes a number of instructions for enabling a computer device (which may be a personal computer, a server, a network device, etc.) or a processor to perform all or part of the steps of the methods described in the various embodiments of the present disclosure. The aforementioned storage medium includes a variety of media such as a USB disk, a mobile hard disk, a read-only memory (ROM), a random access memory (RAM), a magnetic disk, an optical disk, carrier signals, electronic signals, the software distribution medium, and so on. It is noted that the content of the computer-readable storage medium may be increased or decreased according to the jurisdictions and the practice. For example, the computer-readable storage medium may not include the carrier signals and the transmission signals in some jurisdictions.

The above description is merely the embodiments in the present disclosure, the claim is not limited to the description thereby. The equivalent structure or changing of the process of the content of the description and the figures, or to implement to other technical field directly or indirectly should be included in the claim.

What is claimed is:

1. A fully convolutional networks (FCN)-based multivariate time series (MTS) data classification method, comprising:
determining at least one parameter of a multivariate Gaussian model corresponding to the MTS data;
generating input conditions according to the parameter of the multivariate Gaussian model and the MTS data;
establishing correspondence between the input conditions and data categories of the MTS data via learning ability of an artificial intelligence model;
obtaining current MTS data of a target object and determining at least one corresponding current input conditions according to the current MTS; and
determining current data categories corresponding to the current input conditions through the correspondence, specifically, determining data categories corresponding to the current input conditions, further comprising: determining data categories corresponding to the input conditions identical to the current input conditions in the correspondence as the current data categories.

2. The method according to claim 1, wherein the step of determining the parameter of the multivariate Gaussian model corresponding to the MTS data further comprises:
determining a mean matrix of a feature included in the MTS data according to multivariate Gaussian distribution; and
generating a covariance matrix corresponding to a relevant quantization result of the feature of the MTS data according to the mean matrix.

3. The method according to claim 2, wherein the step of generating the input conditions according to the parameter of the multivariate Gaussian model and the MTS data further comprises:
filling the MTS data using cubic spline interpolation to generate multiple pieces of MTS data with an equal length;
generating a mean matrix of the multivariate Gaussian model corresponding to the MTS data;
splicing the mean matrix and the covariance matrix to generate a target matrix; and
generating the input conditions according to the pieces of the MTS data with the equal length, the covariance matrix and the target matrix.

4. The method according to claim 1, wherein the step of establishing the correspondence between the input conditions and the data categories of the MTS data further comprises:
obtaining sample data used to establish the correspondence between the input conditions and the data categories;
analyzing characteristics and rules of the input conditions and determining a network structure and network parameters of an artificial neural network according to the characteristics and the rules; and
training and testing the network structure and the network parameters using the sample data and determining the correspondence between the input conditions and the data categories.

5. The method according to claim 4, wherein the step of obtaining the sample data used to establish the correspondence between the input conditions and the data categories further comprises:
collecting the input conditions and the data categories of different data sources;
analyzing the input conditions and integrating pre-stored expert experience information to select data related to the data categories as the input conditions; and
regarding data pairs constituted by the data categories and the selected input conditions as the sample data.

6. The method according to claim 5, further comprising:
training the network structure and the network parameters, further comprising:
selecting a portion of the sample data as a training sample, inputting the input conditions in the training sample in the network structure, and performing the training by activating a loss function of the network structure and the network parameters to obtain an actual training result;
determining whether an actual training error between the actual training result and corresponding data categories in the training sample corresponds to a preset training error;
when the actual training error corresponds to the preset training error, determining that the training of the network structure and the network parameters is completed;
and/or,
testing the network structure and the network parameters, further comprising:
selecting another portion of the sample data as a test sample, inputting the input conditions in the test sample in the network structure which has been trained, and performing the training via activating the loss function and the network parameters which have been trained to obtain an actual testing result;
determining whether an actual testing error between the actual testing result and corresponding data categories in the testing sample corresponds to a preset testing error; and
when the actual testing error corresponds to the preset testing error, determining that the testing of the network structure and the network parameters is completed.

7. The method according to claim 6, further comprising:
training the network structure and the network parameters, further comprising:
when the actual training error does not correspond to the preset training error, updating the network parameters through an error loss function of the network structure;
re-performing the training by activating the loss function and the updated network parameters until the re-trained actual training error corresponds to the preset training error;
and/or,
testing the network structure and the network parameters, further comprising:
when the actual testing error does not correspond to the preset testing error, re-testing the network structure and the network parameters until the re-trained actual testing error corresponds to the preset testing error.

8. An FCN-based MTS data classification system, comprising at least one processor configured to:
determine at least one parameter of a multivariate Gaussian model corresponding to the MTS data;
generate input conditions according to the parameter of the multivariate Gaussian model and the MTS data;
establish correspondence between the input conditions and data categories of the MTS data via learning ability of an artificial intelligence model;
obtain current MTS data of a target object and determine at least one corresponding current input conditions according to the current MTS; and
determine current data categories corresponding to the current input conditions through the correspondence, specifically, determine data categories corresponding to the current input conditions, further configured to: determine data categories corresponding to the input conditions identical to the current input conditions in the correspondence as the current data categories.

9. The system according to claim 8, wherein the at least one processor is further configured to:
determine a mean matrix of a feature included in the MTS data according to multivariate Gaussian distribution; and
generate a covariance matrix corresponding to a relevant quantization result of the feature of the MTS data according to the mean matrix.

10. The system according to claim 9, wherein the at least one processor is further configured to:
fill the MTS data using cubic spline interpolation to generate multiple pieces of MTS data with an equal length;
generate a mean matrix of the multivariate Gaussian model corresponding to the MTS data;
splice the mean matrix and the covariance matrix to generate a target matrix; and
generate the input conditions according to the pieces of the MTS data with the equal length, the covariance matrix and the target matrix.

11. The system according to claim 8, wherein the at least one processor is further configured to:
obtain sample data used to establish the correspondence between the input conditions and the data categories;
analyze characteristics and rules of the input conditions and determine a network structure and network parameters of an artificial neural network according to the characteristics and the rules; and
train and testing the network structure and the network parameters using the sample data and determine the correspondence between the input conditions and the data categories.

12. The system according to claim 11, wherein the at least one processor is further configured to:
collect the input conditions and the data categories of different data sources;
analyze the input conditions and integrating pre-stored expert experience information to select data related to the data categories as the input conditions; and
regard data pairs constituted by the data categories and the selected input conditions as the sample data.

13. The system according to claim 12, wherein the at least one processor is further configured to:
train the network structure and the network parameters, further comprising:
select a portion of the sample data as a training sample, input the input conditions in the training sample in the network structure, and perform the training by activating a loss function of the network structure and the network parameters to obtain an actual training result;
determine whether an actual training error between the actual training result and corresponding data categories in the training sample corresponds to a preset training error;
when the actual training error corresponds to the preset training error, determine that the training of the network structure and the network parameters is completed;
and/or,
test the network structure and the network parameters, further comprising:
select another portion of the sample data as a test sample, input the input conditions in the test sample in the network structure which has been trained, and perform the training via activating the loss function and the network parameters which have been trained to obtain an actual testing result;
determine whether an actual testing error between the actual testing result and corresponding data categories in the testing sample corresponds to a preset testing error; and
when the actual testing error corresponds to the preset testing error, determine that the testing of the network structure and the network parameters is completed.

14. The system according to claim 12, wherein the at least one processor is further configured to:
train the network structure and the network parameters, further comprising:
when the actual training error does not correspond to the preset training error, update the network parameters through an error loss function of the network structure;
re-perform the training by activating the loss function and the updated network parameters until the re-trained actual training error corresponds to the preset training error;
and/or,
test the network structure and the network parameters, further comprising:
when the actual testing error does not correspond to the preset testing error, re-test the network structure and the network parameters until the re-trained actual testing error corresponds to the preset testing error.

15. A non-transitory computer-readable medium having stored thereon computer instructions, when executed by at least one processor, perform an FCN-based MTS data classification method, the method comprising:
determining at least one parameter of a multivariate Gaussian model corresponding to the MTS data;
generating input conditions according to the parameter of the multivariate Gaussian model and the MTS data;
establishing correspondence between the input conditions and data categories of the MTS data via learning ability of an artificial intelligence model;
obtaining current MTS data of a target object and determining at least one corresponding current input conditions according to the current MTS; and
determining current data categories corresponding to the current input conditions through the correspondence, specifically, determining data categories corresponding to the current input conditions, further comprising: determining data categories corresponding to the input conditions identical to the current input conditions in the correspondence as the current data categories.
